(19) United States
(12) Patent Application Publication
(10) Pub. No.: US 2019/0016068 A1
(43) Pub. Date: Jan. 17, 2019

(54) HIGH SPEED CARBON FIBER CHIP EXPANDER

(71) Applicant: Magna Exteriors Inc., Concord (CA)

(72) Inventor: Stephen B. Putman, Eden Mills (CA)

(21) Appl. No.: 16/033,828

(22) Filed: Jul. 12, 2018

Related U.S. Application Data
(60) Provisional application No. 62/531,966, filed on Jul. 13, 2017.

(51) Int. Cl. B29C 70/50; B62D 33/023; B60J 5/04; C04B 35/83

(52) U.S. Cl. CPC B29C 70/50; B62D 33/023; B29L 2031/3002; C04B 35/83; B60J 5/0483

(57) ABSTRACT

A carbon fiber sheet molding compound expander system incorporating a high speed cutter and an expander. Carbon fiber tow is cut to desired length, and the carbon fiber chips are delivered to the expander to expand and randomize the chips by transvectors of the expander. The expander opens up the chips in a way that allows resin material to contact individual carbon fibers.

### CROSS REFERENCE TO RELATED APPLICATIONS

This application claims the benefit of U.S. Provisional Application No. 62/531,966, filed Jul. 13, 2017. The disclosures of the above application are incorporated herein by reference.

### FIELD OF THE INVENTION

The present invention relates to an expander system for carbon fiber sheet molding compounds useful for components in a vehicle such as lightweight strong liftgates.

### BACKGROUND OF THE INVENTION

Carbon fiber sheet molding compounds (CF SMCs) are generally known. Current systems cut, randomize and expand 50 k carbon tows as desired, but the maximum delivery rate of the system has been reached. The current system is also prone to operational issues leading to downtime. Therefore, there remains a need for a more robust system that also increases the material output of a CF SMC line. Furthermore, there remains a need to further control properties of materials for use in products, such as automotive assemblies, e.g., managing mechanical requirements, managing electric fields or interference, and etc.

One current system is a chopper system that pulls in the carbon fiber tows through a transvector. A series of wheels along a drive shaft, with 9 cutting blades on the perimeter of each wheel, rotate. As the carbon fiber tows pass through the transvector, this opens up each tow and the spinning wheels cut the fiber to length. The result is a fluff “ball” of randomized carbon. This gives the randomized fiber the orientation required so that a resin can coat the fibers to give optimal material properties. But the system has maintenance issues. One issue is that the carbon tows occasionally wrap around the drive shaft causing manufacturing down time. Another issue is there is a large “cut length” distribution, e.g., 1 inch is expected, but 2 inch cut length is possible. Another issue is that the cutting blades need to be set to a very narrow tolerance or else the cutting blades will not chop effectively, e.g. will not cut to desired length and consistently or will not cut completely through the tow.

Another known system incorporates a splitting and spreading system using a cot roll cutter. However, if cutting the standard 50 k tow, the chips will drop, but the resin will not be able to coat the individual fibers resulting in poor material properties. As an improvement over this known system, the 50 k tow could be cut into 3 k to 6 k tows. These thinner tows would then be cut at a high rate and drop. One advantage is that this generates smaller bundles (3 k vs. 50 k) and does it at a high cutting rate. However, there are several disadvantages, including, it does not enable the resin to coat individual fibers; it orients the fibers in the direction of the line (which will cause lower material properties perpendicular to the fibers direction); and, it will be a challenge to join the end of 1 doff with the start of a new doff. In addition, additional randomizing equipment will be required as a countermeasure. Further, if putting a 3 k doff on its own roll, then the system will require a significant number of spool positions in the creel. For example, for a 6 inch wide segment, 96 doffs will be required, consuming a lot of space.

Another known system that includes splitting and spreading system using a cot roll cutter incorporates manufacturing pre-split carbon doffs. The system is the same as set forth above except that the doffs are provided “pre-split” into 3 k bundles. This will cut 3 k bundles to length at a high rate of speed. And the system will consume less space than the splitting and spreading system set forth above. However, this system has similar disadvantages as the system as set forth above. The system does not enable the resin to get to individual fibers; it orients the fibers in the direction of the line (which will cause lower material properties perpendicular to the fiber direction); and, it will be a challenge to join the end of 1 doff with the start of a new doff. Additional randomizing equipment will be required as a countermeasure to the orientation challenge. In addition, pre-splitting the carbon doffs is a specialized process and would result in a higher raw material cost.

### SUMMARY OF THE INVENTION

There is provided a carbon fiber sheet molding compound expander system to cut predetermined fiber tows (e.g., 50 k fiber tows) to the desired length, depending on the application, in a consistent manner. At least one high speed cutter, such as a cot roller or cot roll cutter, cuts the fiber tows to length and feeds the cut fiber tows to at least one expander. The system expands the bundled “chips” so that an optimal amount of resin contacts the fibers. The system also randomizes the fibers in the “puffed up” chip. The system provides high production speeds. The expander expands and randomizes the chips using a plurality of transvectors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a schematic diagram of a carbon fiber sheet molding compound expander system, in accordance with the present invention;

FIG. 1B is a schematic diagram of further detail, taken at area ‘A’ of FIG. 1A, of a mounting plate for a plurality of transvectors and dividers directing expanded chips, in accordance with the present invention;

FIG. 2 is a perspective view of exemplary chips, after cutting of carbon fiber tow, before expansion and randomization by an expander, according to the present invention;

FIG. 3 is a perspective view of exemplary expanded and randomized chips after exiting the expander, in accordance with the present invention;

FIG. 4 is a top perspective view of a transvector bank for a plurality of transvectors, in accordance with the present invention;

FIG. 5 is a bottom perspective view of FIG. 4;

FIG. 6 is a cross sectional side elevation view schematic of a cutter and a collection and distribution system, in accordance with the present invention;

FIG. 7 is a perspective view of a housing with a plurality of chambers of the collection and distribution system, in accordance with the present invention;

FIG. 8 is a top plan view of FIG. 7;

FIG. 9 is a perspective view of the collection and distribution system mounted on a transvector bank, in accordance with the present invention; and

FIG. 10 is a top plan view of FIG. 9.

### DETAILED DESCRIPTION OF THE PREFERRED EMBODIMENTS

The following description of the preferred embodiment(s) is merely exemplary in nature and is in no way intended to limit the invention, its application, or uses.

Referring to the Figures generally, in accordance with the present invention, there is provided a carbon fiber sheet molding compound expander system (or “system”), shown generally at 10, to cut predetermined fiber tows (e.g., 50 k fiber tows) to the desired length, depending on the application, in a consistent manner. 50 k is a preferred standard size. While 50 k is described, it is understood that the tows can be any suitable predetermined tow depending on the application without departure from the scope of the present invention. At least one high speed cutter, such as a cot roller or cot roll cutter, cuts the fiber tows to length and feeds the cut fiber tows to at least one expander. The system expands the bundled “chips” so that an optimal amount of resin contacts the fibers. The system also randomizes the fibers in the “puffed up” chip. The system provides high production speeds. The expander expands and randomizes the chips using a plurality of transvectors.

The system keeps up to the rate of carbon fiber chips delivered by the high speed cutter. This enables the manufacturing site to use the advantages of the “high speed” cutting of the cutter and produces “fluffed” carbon fiber. The chips, preferably, 50 k chips, drop (most preferably, with vacuum assist) into the expander. Here, these chips are expanded and randomized using the transvectors.

Several disadvantages are overcome by the present invention. The advantages according to the present invention include the following:

(i) Allows the resin to contact individual fibers. In particular, the expander opens up the chips in a way that allows the resin to contact the individual fibers.

(ii) Cutting/expanding speed is improved. The cutter (e.g., cot roll cutter) is used on the line, but it could be any style of cutter that provides chips. The system is able to keep up with the higher delivery rate of chips.

(iii) Provides randomized fibers. As the bundles are opened, that process randomizes the fiber orientation.

(iv) Fiber length consistency is provided. Using the cutter (e.g., cot roll cutter) the blades are mechanically set. No matter how fast it turns, it delivers a substantially consistent length.

(v) Allows joining 1 doff to another. Splitting and spreading are not required. Preferably, the standard doffs use 50 k fibers. Optionally, the doffs can be joined like typical and get 50 k joined to 50 k. In a 3 k scenario, repeating the joining process 16 times for the equivalent 50 k is contemplated.

(vi) Standard 50 k tows are used. This allows a standard product that multiple customers use, i.e., “off the shelf”. The system can handle the chips from this standard raw material. Special products (e.g., pre-split doffs) are not needed.

(vii) Space for doffs (creel size) is generally not increased. Since the system uses a typical creel box, additional doff positions are not required.

(viii) Maintenance issues are reduces. This is reduced through using the cot roll cutter to provide the chips, preferably, 50 k chips, to feed the transvector bank.

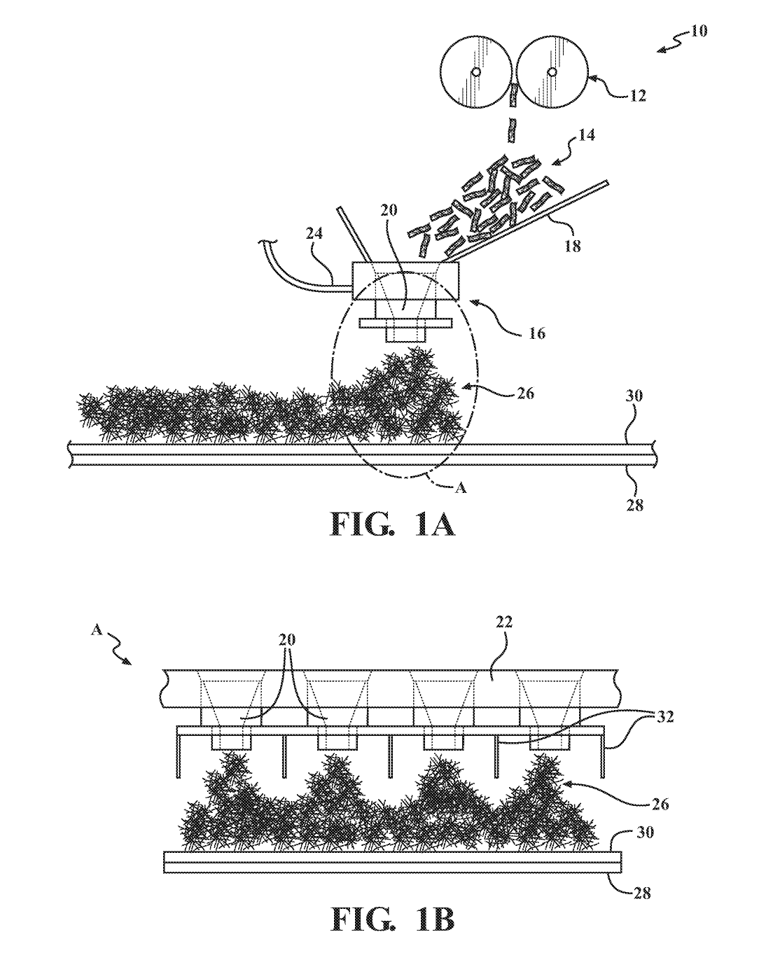

Referring more particularly to FIGS. 1A to 3, there is depicted a schematic of the carbon fiber sheet molding compound expander system 10, according to the present invention. At least one cutter (and/or chopper), shown generally at 12, cuts carbon fiber tows (e.g., 50 k tow) to predetermined desired length to make chips, e.g., 50 k chips, indicated generally at 14. At least one expander, shown generally at 16, receives the chips 14. The system 10 includes a pre-collection/distribution system to direct the chips from the cutter to the Expander. At least one suitable delivery system 18, such as a ramp, a funnel, conveyor belt, slide or any other suitable arrangement, is provided to guide the chips 14 to the expander 16. Preferably, the delivery system 18 is a ramp or a funnel like collection and distribution system that directs the chips 14 to the expander 16. The expander 16 operably expands the chips 14.

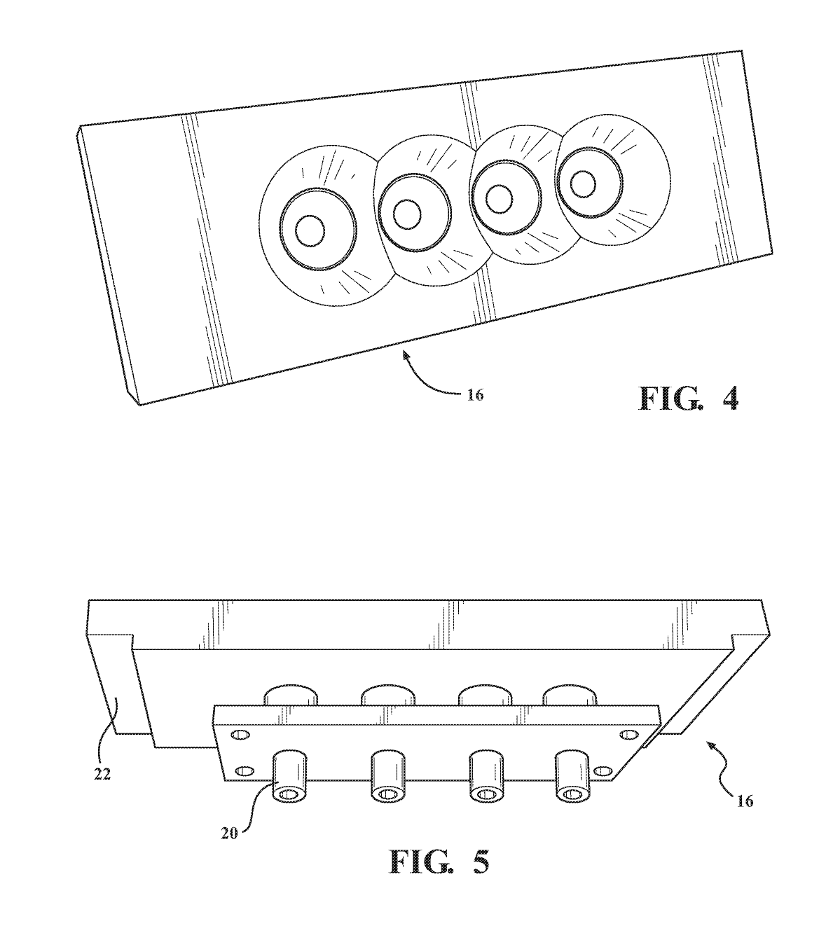

Referring more particularly to FIGS. 1A to 5, preferably, the expander 16 is a transvector bank (see FIGS. 4-5). The transvector bank 16 has a plurality of transvectors 20. In a preferred embodiment, at least one mounting plate 22 is provided for the transvectors 20. A plurality of compressed air lines 24 are coupled to the plurality of transvectors 20, respectively. The transvectors 20 create a vacuum to pull the chips 14 and expand the chips. Expanded chips are indicated generally at 26.

Each transvector 20 has at least one opening 21. The expanded chips 26, after the fiber chips have been opened up, land on a conveyor belt 28 that has resin 30 (giving the lofted appearance of the chopper).

As best shown in FIG. 1B, a plurality of dividers 32 are also provided on the exit side of the transvectors 16 to direct the expanded chips 26 exiting from each transvector 16 toward the resin 30.

The transvector bank 16 includes four transvectors 20. Alternatively, the transvector bank 16 has five transvectors. More or less transvectors 20 are contemplated depending on the application without departure from the scope of the present invention.

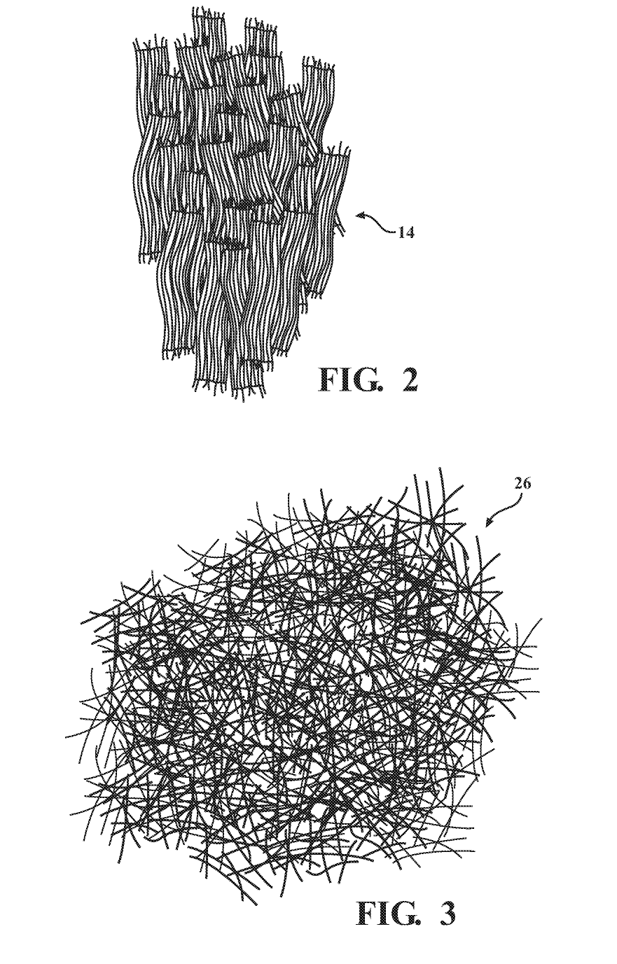

FIG. 2 depicts cut chips, after cutting of carbon fiber 50 k tow by the cutter 12, before expansion and randomization by the expander 16;

FIG. 3 depicts exemplary expanded chips 26 gathered to illustrate the lofting expanding, randomization of chips.

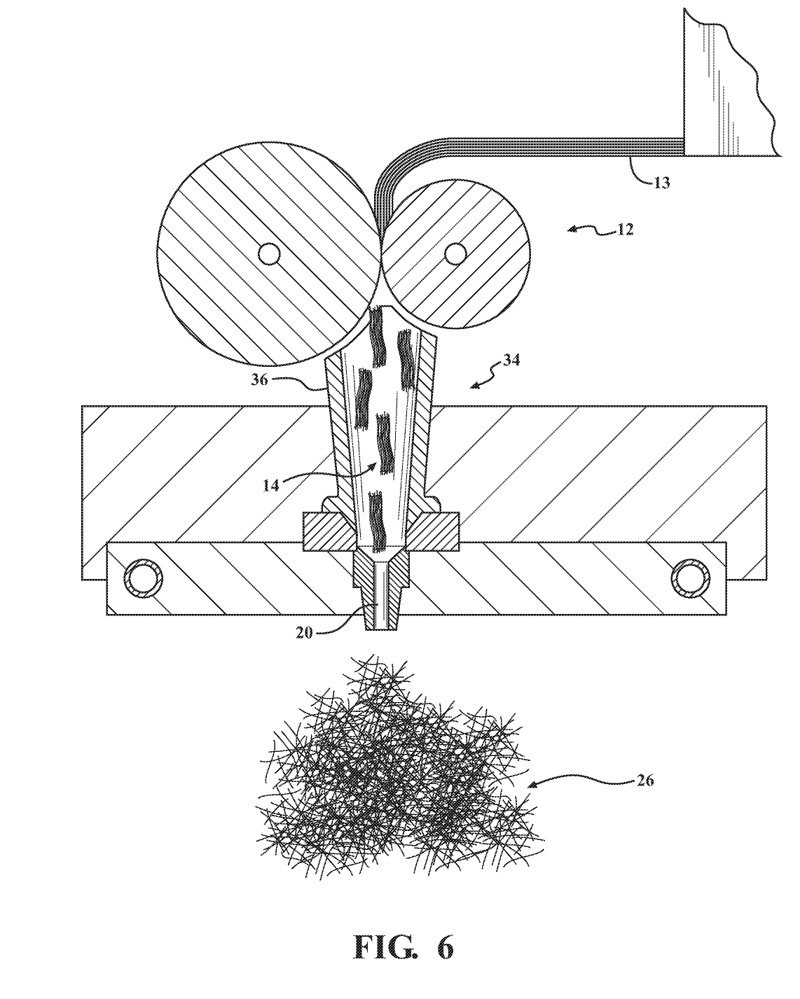

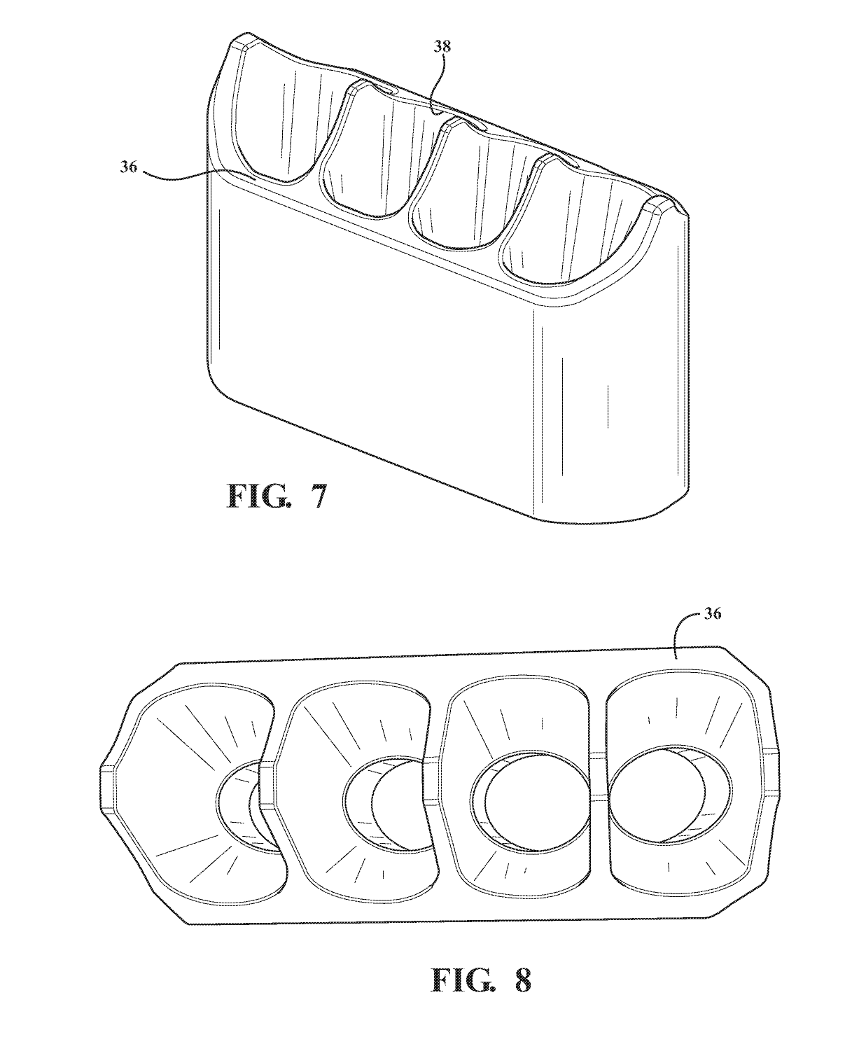

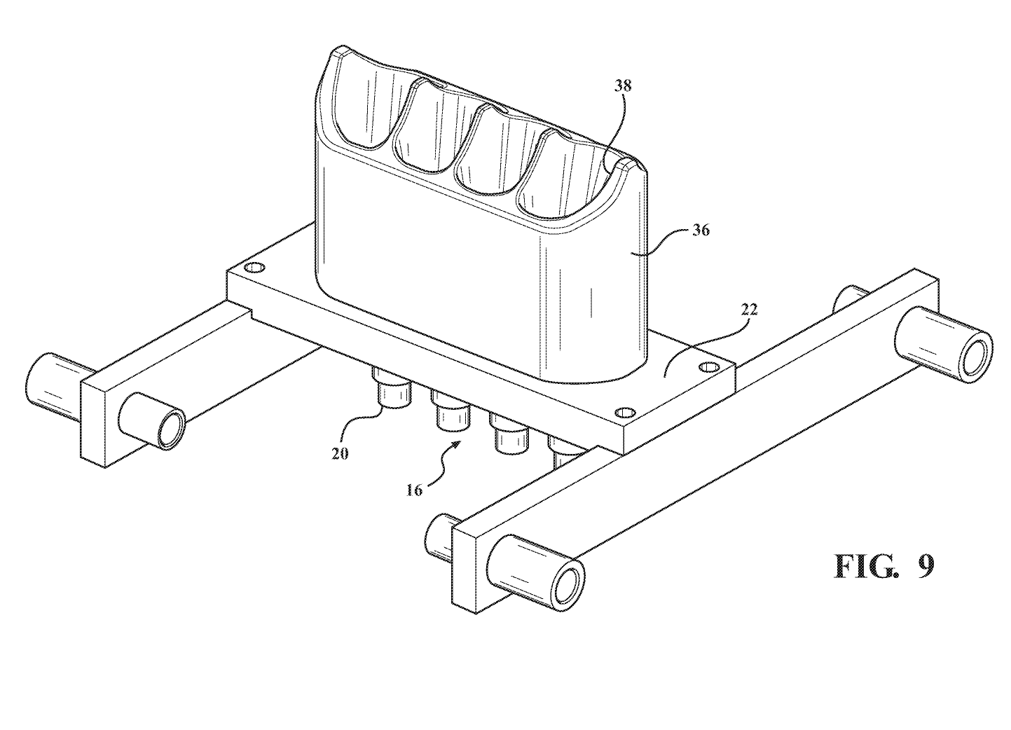

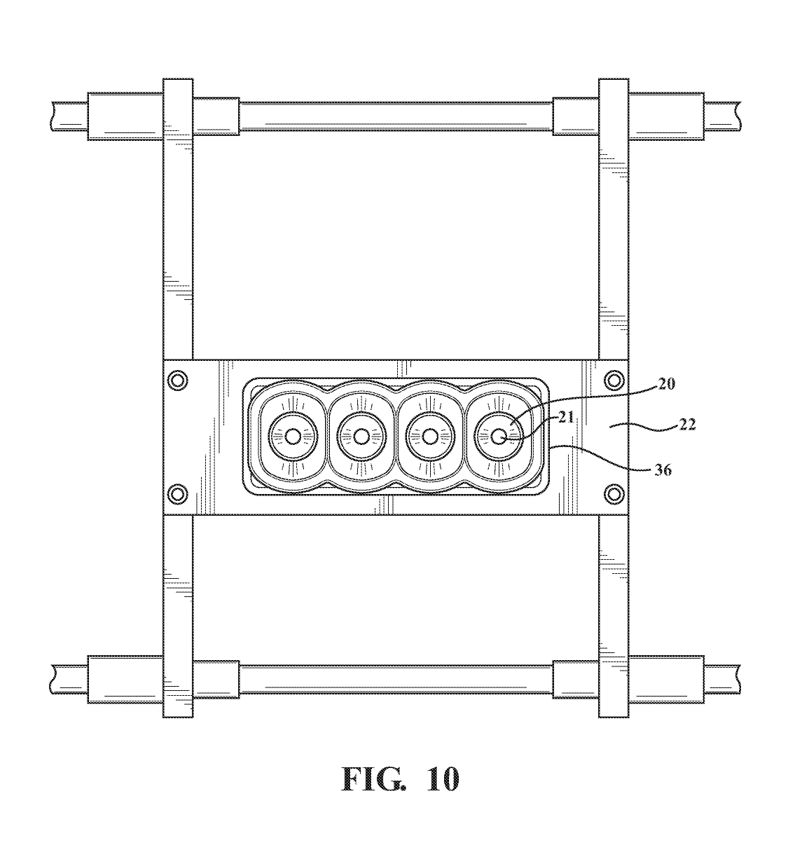

Referring more particularly to FIGS. 6-10, a delivery system shown generally at 34 is provided in accordance with another embodiment of the present invention. The cutter 12 cuts carbon fiber tow 13 and the chips 14 drop into the delivery system 34, which is preferably a funnel-like collection and distribution system, to directs the chips 14 to the plurality of transvectors 20. In a most preferred embodiment, the delivery system 34 includes a housing 36 having a plurality of chambers 38 divided to direct chips 14 to each transvector 20. Each chamber 38 preferably has a funnel-like shape with the smallest diameter adjacent the transvector 20. The housing 38 is mounted to the mounting plate 22 of the transvector bank 16. The transvectors 20 create a vacuum to pull the chips 14 and expand the chips, e.g., venturi effect. The “puffed up” expanded chips 26 exiting the transvectors 20 land on the belt 30 with the resin 28. It is understood that the dividers 32 set forth previously can be mounted on the exit side for guiding the expanded chips 26 to the resin 30. The system is modular in that the expander can grow perpendicular as well as parallel to the manufacturing line by adding transvectors and expanding the mounting bank.

A particularly preferred cot roll cutter for use in the present invention is available from Finn and Fram of North Hills, Calif. A particularly preferred fiber chopper system for use in the present invention is available from Fraunhofer of Munich, Germany. Another particularly preferred fiber chopper system for use in the present invention is available from Brenner International having a place of business in Newark, Ohio.

The carbon fibers selected for the present invention are those suitable for formulation with the SMC chosen and which provide suitable predetermined desired properties.

The carbon fiber also has predetermined sizing and large tow suitable for formulation with the SMC chosen and which provides suitable predetermined desired properties.

Carbon fibers selected for the present invention are those suitable for formulation with the SMC chosen and which provide suitable predetermined properties. The carbon fiber has predetermined sizing and tow suitable for formulation with the SMC chosen and which provides suitable predetermined desired properties. A particularly preferred material for use in the present invention has a 50 k tow.

In accordance with one embodiment of the present invention, the sheet molding composition is filled with an effective amount of the carbon mixture depending on the application. Other fillers, additives and components may be included in minor amounts provided they do not affect the desired properties of the present invention. The material is compatible with epoxy resins depending on the application, according to an embodiment of the present invention. The SMC is a vinyl ester type sheet molding composition (e.g., vinyl ester resin), according to an embodiment of the present invention. In an embodiment of the present invention, the SMC is particularly suited for compression molding, and, preferably is a vinyl ester suitable for structural components, e.g., liftgates, etc. Optionally, a carrier film is used.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A carbon fiber sheet molding compound expander system, comprising:
at least one cutter for cutting carbon fiber tows to predetermined length forming chips;
at least one expander that randomizes fiber orientation and expands said chips so that a resin can coat the expanded chips.

2. The carbon fiber sheet molding compound expander system of claim 1, wherein the chips are 50 k tow.

3. The carbon fiber sheet molding compound expander system of claim 1, wherein the chips drop with vacuum assist into said expander.

4. The carbon fiber sheet molding compound expander system of claim 1, further comprising a ramp or funnel shaped delivery system for collection and distribution of said formed chips from said cutter to direct the fiber chips to said expander.

5. The carbon fiber sheet molding compound expander system of claim 1, wherein said at least one expander includes at least one transvector operable to create a vacuum to pull and expand said chips.

6. The carbon fiber sheet molding compound expander system of claim 1, wherein said expander includes a transvector bank including a plurality of transvectors operable to expand said chips.

7. The carbon fiber sheet molding compound expander system of claim 6, wherein said plurality of transvectors are operably coupled to a plurality of compressed air lines.

8. The carbon fiber sheet molding compound expander system of claim 7, further comprising a delivery system including at least one housing with a plurality of chambers to collect and direct said chips to said plurality of transvectors, respectively.

9. The carbon fiber sheet molding compound expander system of claim 8, wherein each chamber is a funnel with a smaller diameter adjacent each transvector.

10. The carbon fiber sheet molding compound expander system of claim 9, wherein the transvectors are operably coupled to respective compressed air lines and create a vacuum to pull said chips toward said transvectors and expand said chips.

11. The carbon fiber sheet molding compound expander system of claim 7, wherein said transvector bank further comprising a plurality of dividers to direct the expanded fiber chips exiting from each transvector toward a layer of said resin.

12. The carbon fiber sheet molding compound expander system of claim 1, further comprising a conveyor with said resin, wherein said expanded chips land on said resin on said conveyor for coating individual fibers of said expanded chips.

13. The carbon fiber sheet molding compound expander system of claim 1, wherein said cutter is a cot roll cutter operable to provide chips cut to substantially consistent length.

14. A carbon fiber sheet molding compound expander system, comprising:
at least one cutter for cutting carbon fiber tows to predetermined length forming chips;
a pre-collection/distribution system to direct said chips from said cutter to at least one expander, said expander including at least one transvector that expands and randomizes said chips to produce fluffed carbon fiber with randomized fiber orientation, and
at least one conveying system including a resin to coat said fluffed carbon fiber in said resin.

15. The carbon fiber sheet molding compound expander system of claim 14, wherein said cutter includes a plurality of rotating blades that are operably mechanically set to cut said tows to a substantially consistent length at any speed of said rotating blades.

16. The carbon fiber sheet molding compound expander system of claim 14, wherein said at least one expander includes a mounting bank of a plurality of transvectors operably shaped to allow a vacuum that expands and randomizes said chips.

17. The carbon fiber sheet molding compound expander system of claim 16, wherein 50 k chips are feed to the transvector bank.

18. The carbon fiber sheet molding compound expander system of claim 15, wherein said at least one expander includes a funnel shape to feed said chips to each transvector.

19. A method of manufacturing carbon fiber sheet molding compound, comprising:
providing a carbon fiber tow material;
providing a sheet molding resin material;
providing a cutter or a chopper operable for cutting carbon fiber tows to predetermined length forming chips;
providing an expander having a plurality of transvectors operable to expand the chips;
providing a conveyor for carrying the resin material;
cutting the carbon fiber tow to predetermined length to provide cut chips;
supplying compressed air to the plurality of transvectors and expanding the cut chips by the plurality of transvectors creating lofted, randomized chips;
directing the expanded chips onto the resin on the conveyor belt.

20. The method of manufacturing carbon fiber sheet molding compound, further comprising a plurality of dividers, wherein directing the expanded chips includes using said plurality of dividers on the exit side of each transvector onto said resin on said conveyor belt.
